(19) United States
(12) Patent Application Publication
(10) Pub. No.: US 2005/0000916 A1
(43) Pub. Date: Jan. 6, 2005

(54) Process and apparatus for the throughflow sterilization of liquids

(76) Inventors: Peter Ottersbach, Windeck (DE); Beate Kossmann, Marl (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/490,744

(22) PCT Filed: Aug. 31, 2002
(86) PCT No.: PCT/EP02/09754

(30) Foreign Application Priority Data
Oct. 13, 2001 (DE) 101 50 741.0

(51) Int. Cl. C02F 1/68

(52) U.S. Cl. 210/764; 210/206

(57) ABSTRACT

The invention relates to an apparatus and a process for the throughflow sterilization of biologically contaminated liquids.

The invention relates to an apparatus and a process for the throughflow sterilization of biologically contaminated liquids.

It is highly undesirable for bacteria to become established or to spread on the surfaces of pipelines, or of containers or packaging. Slime layers frequently form and permit sharp rises in microbial populations, and these can lead to persistent impairment of the quality of water or of drinks or foods, and even to spoilage of the product, and harm to the health of consumers.

Bacteria must be kept away from all fields of life where hygiene is important. This affects textiles for direct body contact, especially in the genital area, and those used for the care of the elderly or sick. Bacteria must also be kept away from the surface of the furniture and of instruments in patient-care areas, especially in areas for intensive care or neonatal care, and in hospitals, especially in areas where medical intervention takes place, and also in isolation wards for critical cases of infection, and in toilets.

A current method of treating equipment, or the surfaces of furniture or of textiles, to resist bacteria either when this becomes necessary or else as a precautionary measure is to use chemicals or solutions of these, or else mixtures, these being disinfectant and having fairly broad general antimicrobial action. Chemical agents of this type act nonspecifically and are themselves frequently toxic or irritant, or form degradation products which are hazardous to health. In addition, people frequently exhibit intolerance to these materials once they have become sensitized.

Another procedure for counteracting surface spread of bacteria is the incorporation of antimicrobial substances into a matrix.

Another challenge of constantly increasing significance is the avoidance of algal growth on surfaces, since there are many external surfaces of buildings with plastic cladding, which is particularly susceptible to colonization by algae. As well as giving an undesirable appearance, this can in some circumstances also impair the functioning of the components concerned. One relevant example is colonization by algae of surfaces with a photovoltaic function.

Another form of microbial pollution for which again no technically satisfactory solution has been found is fungal infestation of surfaces. For example, Aspergillus niger infestation of joints or walls in wet areas within buildings not only impairs appearance but also has serious health implications, since many people are allergic to the substances given off by the fungi, and the result can even be serious, chronic respiratory disease.

In the marine sector, the fouling of boats' hulls affects costs, since the growth of fouling organisms is attended by an increase in the boat's flow resistance, and thus by a marked increase in fuel consumption. Problems of this type have hitherto generally been countered by incorporating toxic heavy metals or other low-molecular-weight biocides into antifouling coatings, with the aim of mitigating the problems described. To this end, the damaging side effects of coatings of this type are accepted, but as society's environmental awareness rises, this state of affairs is increasingly problematic.

U.S. Pat. No. 4,532,269, for example, therefore discloses a terpolymer made from butyl methacrylate, tributyltin methacrylate, and tert-butylaminoethyl methacrylate. This copolymer is used as an antimicrobial paint for ships, and the hydrophilic tert-butylaminoethyl methacrylate promotes slow erosion of the polymer, thus releasing the highly toxic tributyltin methacrylate as active antimicrobial agent.

In these applications, the copolymer prepared with aminomethacrylates is merely a matrix or carrier for added microbicidal active ingredients which can diffuse or migrate out of the carrier material. At some stage polymers of this type lose their activity, once the necessary minimum inhibitor concentration (MIC) at the surface has been lost.

It is also known from the European patent application 0 862 858 that copolymers of tert-butylaminoethyl methacrylate, which is a methacrylate with a secondary amino function, have inherent microbicidal properties.

The use of antimicrobial polymers for the disinfection of liquids is therefore known.

Nevertheless, the sterilization of water systems and of ultra high purity-water systems represents a major challenge. The requirements placed upon sterilization processes of this type are very stringent, especially in those fields which can give rise to a direct source of contamination for humans, e.g. in the field of pharmaceutical production, or of the processing of drinking water or of other drinks or foods. It is specifically in fields of this type that cold sterilization methods are desirable, since the solutions processed here also comprise temperature-sensitive products. In addition, the amount of energy consumed by sterilization should be as small as possible. UV disinfection systems can only be used for UV-resistant solutions, i.e. not for food or drinks production. Low-molecular-weight biocides cannot by their very nature generally be used for purposes of this type, since these agents can have considerable potential for human toxicity.

Another problem not yet satisfactorily solved is the production of drinking water in developing countries. Plants for this purpose should require little maintenance, be simple to produce, consume little energy, and be highly efficient.

The object on which the present invention is based is therefore to develop a process which does not have the disadvantages described of the prior art for the cold-sterilization of liquids, such as water.

It has been found that throughflow systems which comprise a filling coated with antimicrobial polymers comply with the requirements profile described in an almost ideal manner.

The present invention therefore provides an apparatus for sterilizing liquids, composed of a hollow body which has been filled entirely or partly with a filling or with internals, and through which the liquid flows, wherein the filling or the internals comprise antimicrobial polymers.

The apparatus of the invention may also have an electrical or mechanical pump which can pump the liquid to be sterilized through the apparatus. The liquid may also flow under its own pressure through the apparatus, from a reservoir located above the apparatus.

The location of the filling in the apparatus of the invention is advantageously in a tube or in a closed throughflow cartridge. It is not essential that the filling occupies the entire cavity available, but for efficient sterilization the available surface area with the antimicrobial polymers should be as large as possible.

The filling or the internals may have been prefabricated and may be composed of glass, polymers, metals, or ceramics, for example, or comprise these materials.

For the purposes of the present invention, examples of a filling or internals are: Raschig rings, saddles, Pall rings, tellerettes, wire mesh rings, or wire mesh fabrics. Examples of internals are filter plates, baffles, column trays, and perforated plates. For the purposes of the present invention, possible internals include two or more narrow tubes installed in parallel giving something of the nature of a multitube reactor. Particular preference is given to structured mixer packings or demister packings. These fillings or internals are then subsequently coated with the antimicrobial polymers.

The coating of the filling here may take place directly using a solution of the at least one antimicrobial polymer in a, generally organic, solvent, or using an aqueous dispersion of the antimicrobial polymer.

Solvents which may be used for the coating formulation are almost any of the organic solvents which dissolve the antimicrobial polymer at an adequate concentration. Examples of these include alcohols, esters, ketones, aldehydes, ethers, acetates, aromatics, hydrocarbons, halogenated hydrocarbons, and organic acids, in particular methanol, ethanol, propanol, butanol, acetone, methyl ethyl ketone, butyl acetate, acetaldehyde, ethylene glycol, propylene glycol, THF, diethyl ether, dioxane, toluene, n-hexane, cyclohexane, cyclohexanol, xylene, DMF, acetic acid, and chloroform.

In another version of the process, at least one antimicrobial polymer may be incorporated into a lacquer which is used for the coating of the filling or internals. The antimicrobial polymers may also be applied to the filling by melting or other thermal forming processes. In particular cases it is also possible for the filling used to be the antimicrobial polymers as they stand, particularly in pelletized form.

It is also possible to use a polymer blend made from antimicrobial and non-antimicrobial polymers to produce the filling or the antimicrobial coatings. Examples of non-antimicrobial polymers are polymethyl methacrylate, PVC, polyacrylic acid, polystyrene, polyolefins, polyterephthalates, polyamides, polysulfones, polyacrylonitrile, polycarbonates, polyurethane, and cellulose derivatives.

The antimicrobial polymers are preferably prepared from nitrogen- or phosphorus-functionalized monomers. Particularly suitable antimicrobial polymers for this purpose are those prepared from at least one monomer selected from the group consisting of

2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyidimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether, and 3-aminopropyl vinyl ether.

Besides the monomers mentioned, other aliphatically unsaturated monomers may be used in preparing the antimicrobial polymers. It is not essential that the other aliphatically unsaturated monomers, too, have additional antimicrobial action. Suitable monomers are acrylic or methacrylic compounds, e.g. acrylic acid, tert-butyl methacrylate, or methyl methacrylate, or styrene or its derivatives, vinyl chloride, vinyl ethers, acrylamides, acrylonitriles, olefins (ethylene, propylene, butylene, isobutylene), allyl compounds, vinyl ketones, vinylacetic acid, vinyl acetate, vinyl esters, methyl methacrylate, ethyl methacrylate, butyl methacrylate, tert-butyl methacrylate, methyl acrylate, ethyl acrylate, butyl acrylate, and/or tert-butyl acrylate.

The apparatuses of the invention are suitable for sterilizing any of the liquids in which undesirable bacteria can be present. Examples of these are drinking water, process water in the chemical or pharmaceutical industry, or in industries which process food or drink. The apparatuses of the invention may also be used to sterilize bathing water for mobile showering or washing equipment or swimming pools, or else well water for private use. In the food and drink sector it is possible to sterilize liquid foods or drinks, such as beer, wine, milk, mayonnaise, cremes, ketchup, or soft ice cream, in each case in the form of a final product or of precursors.

The present invention also therefore provides a process for sterilizing liquids comprising water, where the liquid is passed through at least one of the abovementioned apparatuses, for sterilization.

Examples of liquids which may be sterilized using the apparatus of the invention or the process of the invention are the abovementioned liquids, drinking water, waste water, process water, and food or drink in liquid or paste form, where these can be pumped through appropriate apparatuses.

The examples below are given for further description of the present invention and provide additional illustration of the invention but do not restrict its scope as set out in the patent claims.

### EXAMPLE 1

50 ml of tert-butylaminoethyl methacrylate (Aldrich) and 240 ml of ethanol are charged to a three-necked flask and heated to 65° C. under a stream of argon. 0.4 g of azobisisobutyronitrile dissolved in 15 ml of ethanol are then slowly added dropwise, with stirring. The mixture is heated to 70° C. and stirred at this temperature for 6 hours. After expiry of this time, the solvent is removed by distillation from the reaction mixture. The product is then dried in vacuo at 50° C. for 24 hours. The reaction product is then finely ground in a mortar.

### EXAMPLE 1a

1 g of the product from example 1 is dissolved in one liter of cyclohexane. 1000 glass rings of length 7 mm and internal diameter 5 mm, divided into portions of 100 glass rings each, are dipped into this solution, in each case for 10 seconds. The glass rings are then removed and dried for 24 hours at 40° C. in a drying cabinet. The resultant predried coating is then further dried at about 1 mbar in a vacuum drying cabinet at 35° C. for 24 hours. The dried glass rings are placed in a glass tube of length 1 m and diameter 8 cm, both openings of which are sealed with glass wool, and the lower outflow of which has a valve to regulate throughflow.

### EXAMPLE 1b

The glass tubes from example 1a are clamped vertically into a stand, and one liter of a microbial suspension of Staphylococcus aureus which has 107 microbes per ml is added from above. A throughflow of about 50 ml per minute is set by adjusting the outflow valve. Once all of the microbial suspension has passed through, the number of microbes is again measured. No remaining Staphylococcus aureus microbes are detectable.

### EXAMPLE 1c

The glass tubes from example 1a are clamped vertically into a stand, and one liter of a microbial suspension of Pseudomonas aeruginosa which has 107 microbes per ml is added from above. A throughflow of about 50 ml per minute is set by adjusting the outflow valve. Once all of the microbial suspension has passed through, the number of microbes is again measured. The number of microbes has fallen to 10³ microbes per ml.

### EXAMPLE 2

40 ml of dimethylaminopropylmethacrylamide (Aldrich) and 200 ml of ethanol are charged to a three-necked flask and heated to 65° C. under a stream of argon. 0.4 g of azobisisobutyronitrile dissolved in 20 ml of ethanol are then slowly added dropwise, with stirring. The mixture is heated to 70° C. and stirred at this temperature for 6 hours. After expiry of this time, the solvent is removed by distillation from the reaction mixture and the product is then dried in vacuo at 50° C. for 24 hours. The reaction product is then finely ground in a mortar.

### EXAMPLE 2a

1 g of the product from example 2 is dissolved in one liter of cyclohexane. 1000 glass rings of length 7 mm and internal diameter 5 mm, divided into portions of 100 glass rings each, are dipped into this solution, in each case for 10 seconds. The glass rings are then removed and dried for 24 hours at 40° C. in a drying cabinet. The resultant predried coating is then further dried at about 1 mbar in a vacuum drying cabinet at 35° C. for 24 hours. The dried glass rings are placed in a glass tube of length 1 m and diameter 8 cm, both openings of which are sealed with glass wool, and the lower outflow of which has a valve to regulate throughflow.

### EXAMPLE 2b

The glass tubes from example 2a are clamped vertically into a stand, and one liter of a microbial suspension of Staphylococcus aureus which has 107 microbes per ml is added from above. A throughflow of about 50 ml per minute is set by adjusting the outflow valve. Once all of the microbial suspension has passed through, the number of microbes is again measured. The number of microbes has fallen to 103 microbes per ml.

### EXAMPLE 2c

The glass tubes from example 2a are clamped vertically into a stand, and one liter of a microbial suspension of Pseudomonas aeruginosa which has 10⁷ microbes per ml is added from above. A throughflow of about 50 ml per minute is set by adjusting the outflow valve. Once all of the microbial suspension has passed through, the number of microbes is again measured. The number of microbes has fallen to 1 microbes per ml.

### EXAMPLE 3

16 ml of tert-butylaminoethyl methacrylate (Aldrich), 45 g of Triton X 405 (Aldrich), 200 ml of deionized water, and 0.6 g of potassium peroxodisulfate (Aldrich) are charged to a three-necked flask and heated to 60° C. under a stream of argon. A further 180 ml of tert-butylaminoethyl methacrylate are then slowly added dropwise over a period of 4 hours. The mixture is then stirred for a further 2 hours at 60° C., and then the resultant emulsion is allowed to cool to room temperature.

### EXAMPLE 3a

5 g of the product from example 3 is diluted in one liter of water. 1000 glass rings of length 7 mm and internal diameter 5 mm, divided into portions of 100 glass rings each, are dipped into this dispersion, in each case for 10 seconds. The glass rings are then removed and dried for 24 hours at 40° C. in a drying cabinet. The resultant predried coating is then further dried at about 1 mbar in a vacuum drying cabinet at 35° C. for 24 hours.

The dried glass rings are placed in a glass tube of length 1 m and diameter 8 cm, both openings of which are sealed with glass wool, and the lower outflow of which has a valve to regulate throughflow.

### EXAMPLE 3b

The glass tubes from example 3a are clamped vertically into a stand, and one liter of a microbial suspension of Staphylococcus aureus which has 10⁷ microbes per ml is added from above. A throughflow of about 50 ml per minute is set by adjusting the outflow valve. Once all of the microbial suspension has passed through, the number of microbes is again measured. The number of microbes has fallen to 10³ microbes per ml.

### EXAMPLE 3c

The glass tubes from example 3a are clamped vertically into a stand, and one liter of a microbial suspension of Pseudomonas aeruginosa which has 10⁷ microbes per ml is added from above. A throughflow of about 50 ml per minute is set by adjusting the outflow valve. Once all of the microbial suspension has passed through, the number of microbes is again measured. The number of microbes has fallen to 103 microbes per ml.

1. An apparatus for sterilizing liquids, which comprises:
a hollow body which has been filled entirely or partly with a filling or with internals, and through which the liquid flows,
wherein
the filling or the internals comprise antimicrobial polymers.

2. The apparatus as claimed in claim 1,
wherein
the filling or the internals have been coated with antimicrobial polymers.

3. The apparatus as claimed in claim 1,
wherein
the filling or the internals are composed of a polymer blend made from antimicrobial and non-antimicrobial polymers.

4. The apparatus as claimed in claim 1,
wherein
the antimicrobial polymers are prepared from nitrogen- or phosphorus-functionalized monomers.

5. The apparatus as claimed in claim 1,
wherein
the antimicrobial polymers are prepared from at least one monomer selected from the group consisting of
2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2—diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyl-oxyethyltrimethylammonium methosulfate, 2-diethylominoethyl methacrylate, 2-methacryloyloxyethyltrimethylammonium chloride, 3-methacryloylaminopropyltrimethyl-ammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether, and 3-aminopropyl vinyl ether.

6. The apparatus as claimed in claim 5,
wherein
the antimicrobial polymers are also prepared using another aliphatically unsaturated monomer.

7. The apparatus as claimed in claim 1,
wherein
the filling or the internals comprise glass, polymers, metals, or ceramics.

8. A process for sterilizing liquids comprising water,
which comprises
passing the liquid through at least one apparatus as claimed in claim 1, for sterilization.

9. The process as claimed in claim 8,
wherein
the liquid comprising water is drinking water, waste water, process water, or food or drink in liquid or paste form.
